(19) United States
(12) Patent Application Publication
(10) Pub. No.: US 2026/0208584 A1
(43) Pub. Date: Jul. 23, 2026

(54) VEHICLE CABIN MONITORING AND WARNING SYSTEM AND METHOD

(71) Applicant: UNIVERSITY OF JEDDAH, Jeddah (SA)

(72) Inventors: Abdulrahman A ALSHDADI, Jeddah (SA); Sajjad Hussain CHAUHDARY, Jeddah (SA); Mohammed A. ALQARNI, Jeddah (SA)

(21) Appl. No.: 19/033,940

(22) Filed: Jan. 22, 2025

(51) Int. Cl. B60K 35/28; B60K 35/10; B60W 50/14

(52) U.S. Cl. CPC B60K 35/28; B60K 35/10; B60W 50/14

(57) ABSTRACT

A vehicle cabin monitoring and warning system includes a sensor array located within a cabin of a vehicle, and a data server located on the vehicle, and in communication with the sensor array. The data server is configured to determine a presence of a living being inside the cabin, based on readings from one or more sensors of the sensor array, and the data server is configured to transmit, in a wireless manner, an alert message to a person associated with the vehicle, the alert message including a location of the vehicle and also an indication about a given parameter that is abnormal with regard to the cabin.

### BACKGROUND OF THE INVENTION

### Technical Field

Embodiments of the subject matter disclosed herein generally relate to a vehicle's cabin monitoring and warning system, and more particularly, to a system that collects data impacting a cabin of a vehicle and generates an alert message if a living being is present inside the cabin and one or more conditions negatively impact a safety and/or health of the living being inside the cabin.

### Discussion of the Background

More reports are being published in which a person or a pet (a living being) are unintentionally left inside the cabin of a car, under life threatening conditions (e.g., intense heat), which sometimes results in a medical condition or even death. This is happening mainly because of extreme temperature conditions, lack of oxygen, or even a chemical gas reaction that is triggered by the extreme temperatures. Under a different scenario, but having the same negative results, an occupant of a vehicle (e.g., a passenger or an employee of a certain business), finds himself or herself being stuck in the cabin of the vehicle under extreme conditions and not being able to leave the cabin. For example, despite the crew's physical inspection of a stopped or parked train, bus, or aircraft, it is still possible for a passenger or employee to become caught in that vehicle.

Public Opinion Strategies of Washington, D.C. conducted a national internet poll with regard to these issues. The results of these surveys were presented at the National Lifesavers Conference on Highway Safety Priorities, an annual gathering of more than 2,000 road safety activists and professionals. The results were obtained from the feedback of 1,000 parents and caregivers who transport children aged six and younger to various activities (e.g., school, daycare, sport events, shopping, etc.). According to the survey, nearly seven out of ten (69%) parents said they had heard of kids getting heat stroke in cars, yet some were still prepared to make an exception for their own kids (i.e., leaving their kids for a short time inside the car unsupervised). Specifically, 14% of the parents surveyed admitted to purposefully leaving their young children—infants, toddlers, and kindergarteners—alone in a parked car for a short period of time. Based on the U.S. population, that translates to over 2 million adults driving over 3.3 million kids. The proportion rises to 23% for parents of children under the age of three.

More than 1.5 million parents, who are responsible for more than 2.6 million children, say that they have left their kids in the car for various periods of time while they attended to a certain activity outside the car. It is almost one in four for individuals who have children under three. Dads are almost three times as likely as moms to leave a child unattended in a parked car; their rate is 23% versus 8%.

Furthermore, 6% (more than 840,000 parents with approximately 1.5 million kids) are at ease with their young children spending more than 15 minutes in a parked, locked vehicle, as discussed in [1].

The noted survey explains the potential for harmful situations inside the car's cabin, for example, could induce fainting or death in a stationary vehicle due to heatstroke, a lack of oxygen, an extremely cold environment, or any type of chemical gas reaction. In this regard, the quality of the air within the car, which is crucial for the passengers'safety, is the main emphasis of [1]. The authors in [1] proposed to monitor: pollutant gases entering the vehicle via the ventilation system, a lack of fresh airflow resulting in low oxygen and high carbon dioxide concentration, pollutant gases entering from the outside via a window opening or other imperfect seals in the car cabin, or toxic gases entering the cabin, to inform the vehicle's owner and driver about these conditions.

The authors in [2] performed a study on the thermal accumulation and distribution inside a parked automobile cabin. The study focuses on the interior parts of the cabin that deteriorate due to the collected heat inside the car cabin and are typically vulnerable to wear and strain. No consideration is given in these studies for the presence of a living being inside the cabin. The authors in [3] examined the air temperature and humidity in various regions, including inside a car, when the door is open or the horn is honking, as this could lead to theft, kidnapping, or other issues.

However, the above studies do not address how to overcome a life threatening situation that may be experienced by a human or pet inside the car cabin. Thus, there is a need for a safety system and method that are capable of alerting a person outside the car about a life threatening situation taking place inside the car.

### SUMMARY OF THE INVENTION

According to an embodiment, there is a vehicle cabin monitoring and warning system that includes a sensor array located within a cabin of a vehicle and a data server located on the vehicle, and in communication with the sensor array. The data server is configured to determine a presence of a living being inside the cabin, based on readings from one or more sensors of the sensor array and the data server is configured to transmit, in a wireless manner, an alert message to a person associated with the vehicle, the alert message including a location of the vehicle and also an indication about a given parameter that is abnormal with regard to the cabin.

According to another embodiment, there is a method for monitoring a vehicle cabin and generating an alert message when a threatening situation is detected. The method includes activating a monitoring and warning system, located on the vehicle, when the vehicle is stationary for a given time period, measuring a motion and an occupancy inside the cabin with a sensor array located within the cabin, determining, at a data server of the monitoring and warning system, which is in communication with the sensor array, a presence of a living being inside the cabin, based on readings from the sensor array, and generating and transmitting, from the data server, an alert message, to a person associated with the vehicle, the alert message including a location of the vehicle and also an indication about a given parameter that is abnormal with regard to the cabin.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a motion and warning system distributed in a vehicle;

FIG. 2 is a flow chart of a method that determines the presence of a living being inside a vehicle and alerts a person associated with the vehicle if a life threatening condition is detected inside the vehicle; and FIG. 3 is a flow diagram illustrating the flow of data for the motion and warning system of FIG. 1.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a passenger car. However, the embodiments to be discussed next are not limited to a passenger car, but may be applied to other vehicles, for example, trains, boats, commercial vehicles, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a monitoring and warning system may be attached to a vehicle (e.g., a passenger car), either during the manufacturing process of the car or as an after sale event. The monitoring and warning system includes several sensors that are configured to be located inside-the-vehicle and these sensors are configured to sense one or more internal conditions of the cabin (e.g., oxygen, excessive sunlight, heat, or cold, or the presence of a harmful chemical, or smoke) of a stationary vehicle in the presence of living beings. Sensed data is gathered at a data server or gateway located inside the vehicle. The information is locally processed by the data server, based on predetermined thresholds related to various possible life threatening conditions inside the vehicle.

The user, owner, driver, or a selected person associated with the vehicle is alerted when the data server determines that a critical situation is taking place and potentially affecting the well-being of the living being inside the cabin. The monitoring and warning system warns, for example, by sending a message or placing a call, a device of the user, owner, driver, or selected person according to predefined specifications, which are discussed later. The message or call may also include a geographical location of the vehicle along with the calculated threat or situation occurring inside the cabin.

In one application, the monitoring and warning system increases the passenger's safety inside the vehicle during the stationed/parking time. For example, the vehicle owner/user/authorized individual may be able to monitor the conditions inside the cabin of the vehicle during the parking time by using the monitoring and warning system. In other words, the data collected by the monitoring and warning system may be transmitted to the user of the vehicle even when no threatening conditions are detected inside the vehicle. Thus, the vehicle owner may be able to leave the living being inside the vehicle for a short period of time, during the parking, to complete their daily routine by knowing exactly the value of one more parameters inside the car (e.g., temperature, humidity and O₂ level). Thus, this system may provide lifesaving capabilities for the human beings and/or other living beings (pets) when they are left inside the vehicle and a critical situation develops.

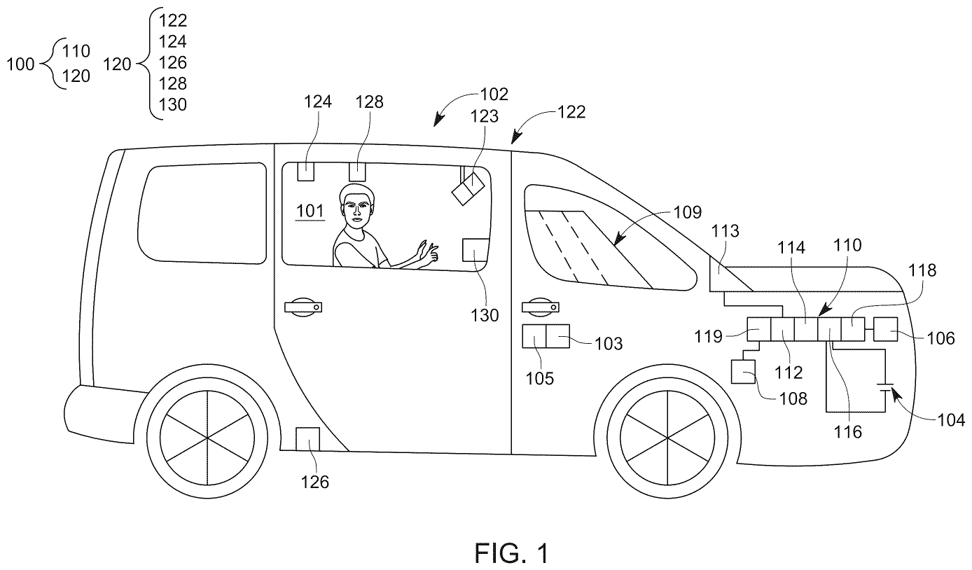

More specifically, a monitoring and warning system 100 is illustrated in FIG. 1 and includes a data server 110 and a sensor array 120. In one application, both elements 110 and 120 are located inside a cabin 101 of a vehicle 102. The data server 110 may include a processor 112 for processing the various data received from the sensor array 120. The processor 112 interacts with a memory 114, which is configured to store: the data acquired from the sensor array 120, various thresholds that are applied by the processor when determining that a condition is life threatening, and also various information (protocols) for calling a mobile phone or another device. The processor 112 and memory 114 may be provided with an independent energy source 116, for example, a battery. Alternatively, the data server 110 may be connected to the battery 104 of the vehicle 102. In one embodiment, the data server 110 may also include a transceiver 118, for communicating with a mobile phone, or a WiFi enabled device, or with a Bluetooth enabled device, or with a radio tower that user a radio frequency (RF) communication protocol. In one application, the data server 110 is linked/connected to the car's communication system 106, if the car has such a system. Those skilled in the art would understand that other electronic equipment may be added to the data server, for example, various ports 119 for communicating with various elements of the vehicle 102, for example, its central controller 108. In this way, as discussed later, the data server 110 may directly interact with the vehicle 102, for example, for closing or opening its windows 109, or starting its engine 103 or its air conditioning system 105. Note that the data server 110 is shown in FIG. 1 as having all its components being located at a same location. However, in one embodiment, the data server 110 may have its components distributed throughout the vehicle.

The sensor array 120 may include one or more sensors. One of such a sensor is a motion sensor 122 (e.g., a passive infrared sensor, a microwave sensor, an ultrasonic sensor, a dual technology sensor, an indoor security camera, or a smart home camera). This sensor is configured to detect the movement of a living being inside the cabin of the vehicle. Depending on the size of the vehicle, more than one motion sensor 122 may be used. In one application, a first motion sensor 122 is an actual sensor and a second motion sensor 122 is a motion camera. The type of sensor to be integrated in the monitoring and warning system 100 may be determined based on whether the system is added to the car after being manufactured or during the manufacturing process. Also, the type of motion sensor 122 to be added to the vehicle depends on the price of the car, i.e., for an entry level car for which the price needs to be kept low, a physical motion sensor is preferred while for a high end car, a camera is preferred. The motion sensor 122 may have its own energy source 123, e.g., a battery, or it may be integrated (e.g., wired) to the battery 104 of the vehicle or the power source 116 of the system 100. The motion sensor 122 may be wired to the data server 110 or may be connected in a wireless manner.

Another possible sensor of the sensor array 120 is a vibration sensor 124. A vibration sensor is a device which is capable to sense a vibration/trembling of the vehicle or the living being (e.g., human or animal). This sensor is placed within the cabin of the vehicle. In one application, a number of vibration sensors 124 may be used, depending on the size of the vehicle. The vibration sensors 124 are connected (wired or wireless connection) to the data server 110. Examples of a vibration sensor 124 includes a piezoelectric accelerometer, which converts a mechanical vibration into an electrical signal, a seismic sensor, which detects ground motion, or an acoustic sensor, which detect vibrations in the form of sound waves.

Another possible sensor of the sensor array 120 is a temperature and humidity sensor 126. A temperature and humidity sensor is a device which is capable of sensing the temperature and humidity inside the vehicle. An example of such a sensor is SHT1x manufactured by Sensirion, or BMExxx manufactured by Bosch Sensortec, or HDCxxx manufactured by Texas Instruments. This sensor is located within the cabin 101 of vehicle 102, at one or more locations. The number of temperature and humidity sensors can increase or decrease depending on the size of vehicle. The temperature and humidity sensors are connected (wired or wireless connection) to the data server 120. Note that in one application, the temperature and humidity sensor 126 may be replaced with only a temperature sensor, only a humidity sensor, or a combination of a temperature sensor and a humidity sensor.

Another possible sensor of the sensor array 120 is an oxygen sensor 128. The oxygen sensor 128 is a device which is capable of sensing oxygen quality and level inside the cabin 101 of the vehicle 102. This sensor is located, within the cabin of the vehicle, at one or more locations. The location may be at the top of the cabin, bottom of the cabin, or at the head level of the passenger. The number of oxygen sensors may increase or decrease depending on the size of vehicle. The oxygen sensors are connected (wired or wireless connection) to the data server 120. In one application, the oxygen sensor is replaced by a CO₂ and/or CO sensor. In yet another application, the oxygen sensor is augmented by the CO₂ or CO sensor.

Another possible sensor of the sensor array 120 is an occupancy sensor 130. The occupancy sensor 130 is a device which is capable of sensing the presence of a living being inside the cabin of the vehicle. This sensor is located within the cabin of the vehicle, preferably in the rear part of the cabin. In one application, the occupancy sensor may be located on the living being, for example, a tracking device used for a pet, or a mobile phone used by a human being. The occupancy sensor may be a capacitive sensor, a pressure sensor, a microphone, an infrared sensor, etc. The capacitive sensor measures a change in the capacitance caused by the presence of a capacitive body, for example, the living being. Such a sensor may be used in an existing vehicle for triggering an airbag deployment or a seatbelt reminder. The pressure sensor detects a pressure change due in the seat cushion. In one application, a pressure sensor is used together with a capacitive sensor for more accurate occupancy detection. In yet another application, the occupancy sensor is or may include a microphone. An infrared sensor detects a heat signature of the living being. The number of occupancy sensors may increase or decrease depending on the size of vehicle. The occupancy sensors are connected (wired or wireless connection) to the data server 120. Note that in one embodiment, all the sensors of the sensor array 120 are connected to the data server 110 in a closed system, i.e., no other sensor of the vehicle or of the living being is connected to the data server 110.

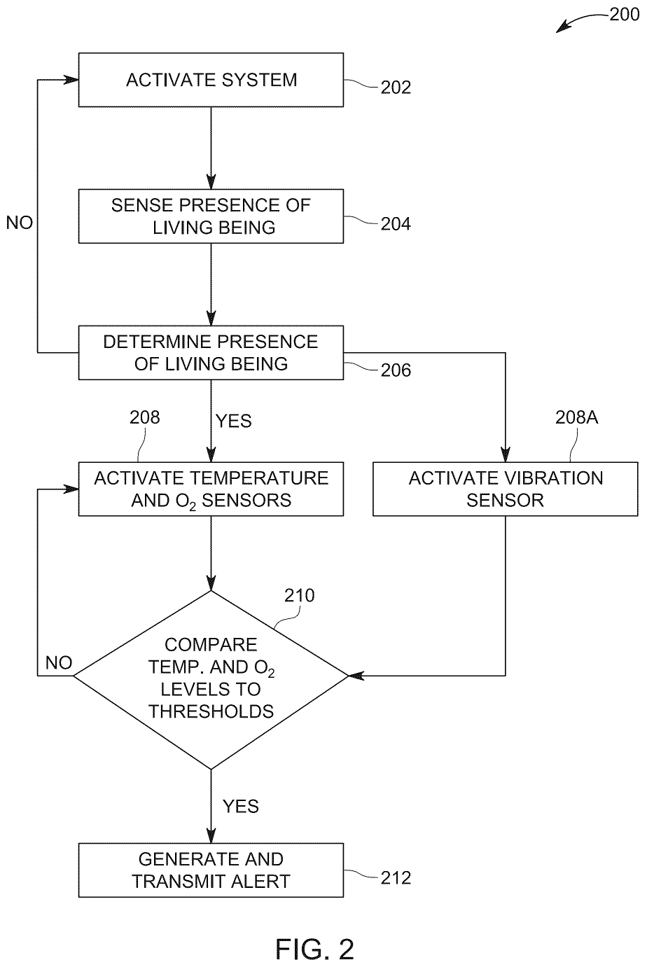

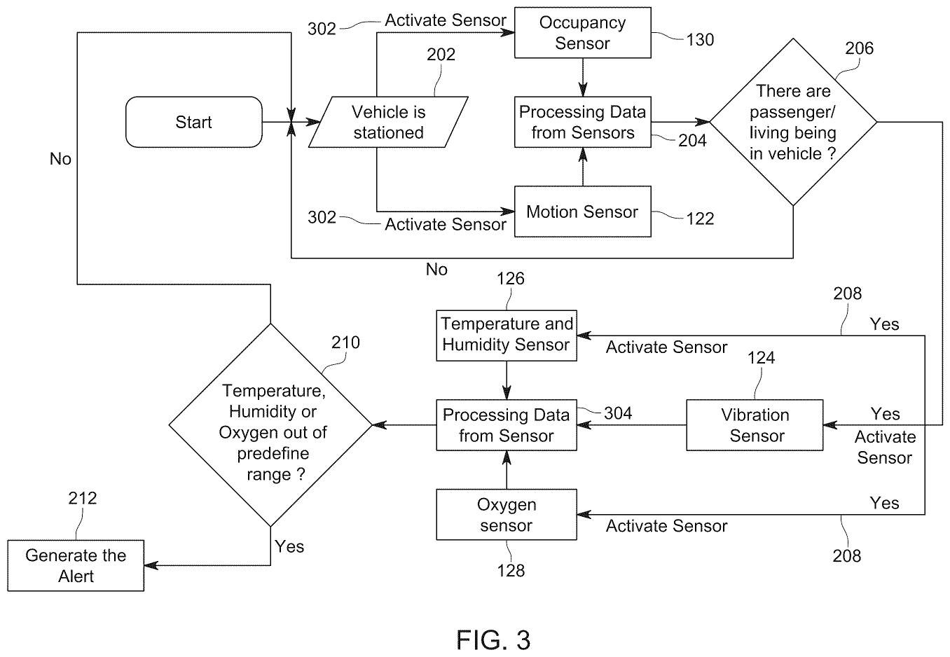

The data server 110 is configured to process the data received from the various sensors of the sensor array 120 to assess the presence of the living being, determine whether a threatening situation is present, and then alert a selected device or person to warn about the threatening situation. In one application, one or more methods/algorithms are implemented in the memory 114 and run by the processor 112 for performing these functions. One such method 200 is now discussed with regard to FIGS. 2 and 3. FIG. 2 is a flow chart of the method 200 while FIG. 3 schematically illustrates the data flow between the sensors of the sensor array 120 and the data server 110.

The method 200 starts with step 202, in which the monitoring and warning system 100 is activated. In one embodiment, the data server 110 activates the sensor array 120 when determining that the vehicle 102 is stationary. In one embodiment, in the interest of saving energy, which may be limited during the time the monitoring and warning system 100 is active, the system 100 is inactive as long as the vehicle is moving. The system 100 (in one example, the data server 110) is activated only when the vehicle is parked or stationed for longer than a given time (for example, 2 minutes or more, but other values may be used). In one application, the data server 110 has access to the central controller 108 of the vehicle 102 and determines that the vehicle is stationary when the engine is not engaged, or there is no car key present, where the car key is associated with the engine ignition.

However, other indications may be used by the system 100 for determining that the vehicle is not moving, e.g., a pressure sensor in the driver seat detects that the driver is missing, or the safety belt of the driver is disengaged, or the driving wheel is not turned for a given time, or the acceleration pedal is not pressed for a given time, etc. Following step 202, the sensors of the sensor array 120 are activated 302 (see FIG. 3) and the data server 110 is ready to receive and process the readings from the sensor array 120.

In step 204, the motion sensor 122 and/or occupancy sensor 130 start sensing the presence of the living being inside the cabin of the vehicle, based on the motion or presence of the living being and sends this data to the data server 110. In step 206, the data server 110 processes the readings from the motion sensor 122 and/or occupancy sensor 130 and determines whether the living being is present in the cabin. For example, the data server 110 compares the readings from sensors 122 and/or 130 with established threshold values and if these values are higher than the threshold values, the data server decides that there is a living being inside the cabin. In one application, the determination is made based on both the motion sensor readings and the occupancy motion readings, i.e., both readings need to be outside a corresponding range to determine the presence of the living being. In another application, the presence of the living being is determined when at least one of the readings from the sensors 122 and 130 is outside the corresponding range. If the result of this step is negative, i.e., no living being is present inside the cabin, the method may return to step 202 or may simply become inactive for a certain time period (e.g., 2 minutes or more) until it is again activated. If the result of this step is positive, i.e., a living being is determined to be present inside the cabin, then the data server 110 activates in step 208 the temperature and humidity sensor 126 and the O₂ sensor 128 and these sensors start collecting the corresponding data.

The temperature and humidity sensor 126 and the O₂ sensor 128 collect the corresponding data and transmit it to the data server 110. The data server 110 analyzes in step 210 (also step 304 in FIG. 3) the received data, for example, comparing it to predetermined threshold values stored in the memory 114. If all these parameters (temperature, humidity, oxygen level, CO₂ level, etc.) are within the predetermined ranges, or between predetermined thresholds, NO branch in FIG. 2, then the data server 110 takes no further action, and waits until the sensors 126 and 128 provide the next readings, i.e., the method returns to step 208. The time interval between the readings may be 2 or more minutes.

However, if one or more of the reported parameters are outside the corresponding ranges (defined by the corresponding thresholds), YES branch in FIG. 2, then the data server 110 generates an alert message (simply called “an alert”) in step 212. The alert may include an indication about the location of the vehicle and also an indication about what parameter was determined to be out of range. The location of the vehicle may be obtained from the GPS system of the vehicle. In another embodiment, the system 100 may include a GPS system.

In one application, the temperature range is considered to be about 35 to 38° C., as the normal body temperature is about 37° C. Note that a critical temperature is considered to be about 41° C. Other numbers for the temperature range may be used. In terms of the humidity range, in one application, the humidity range is set to be about 20 to 80%, where a 30 to 50 % range is considered to be ideal for human comfort. In terms of oxygen, the oxygen range is selected, in one embodiment, to be about 19 to 24 %. Any of the measured parameters in step 208 that fall outside these ranges, will make the data server 110 to generate the alert 212. Those skilled in the art would understand that the values of these ranges may change. In one embodiment, the system 100 has an input/output interface 113 (see FIG. 1), which interacts with the processor 112, and the interface 113 may be used by the driver or the owner of the vehicle to adjust/modify the above parameter ranges (thresholds).

The system 100 also sends the alert message in step 212. For example, the alert message may be sent in a wireless manner to the phone of the driver or owner of the car. The phone number of the driver or owner of the car may be input into the system using the interface 113. In one application, the system 100 has access to the central controller 108 of the car, and the central controller 108 has access to the driver or owner's phone. In one application, the system 100 sends the alert message (in a wireless manner) to a car managing company, e.g., the manufacturers of the new cars maintain a maintenance service over air for each car and thus, they are able to communicate with the car. In another application, the owner or driver of the car may input through the interface 113 the details of a rescue service, like an emergency service, and the alert is sent directly to such service. In one application, the system 100 sends the alert message to multiple devices/persons, e.g., the owner of the car, the driver of the car, a spouse of the owner/driver of the car, etc. The owner of the car can select, through the input interface 113 one or more persons/companies to receive the alert message.

In one application, step 212 includes a first substep in which the system 100 sends the alert to the driver or owner of the car. If the system does not receive a message/command from the driver or owner, within a given time period (e.g., 3 minutes, but other values may be used), then the system 100 sends, during a second substep, the alert message to another person or to the emergency service. Alternatively or in addition, the system 100 may communicate with the central controller 108 to initiate opening the windows 109 or starting the engine 103 of the vehicle, or activating the air conditioning unit 105 of the vehicle to control one or more measured parameters, to alleviate the threatening situation. In one application, these substeps may happen at the same time. In another application, the system 100 initiates the various components of the car discussed above to remedy the threatening situation and then alerts the owner or driver with the alert message.

The system 100 is configured to also activate the vibration sensor 124 in optional step 208A, when the presence of the living being is detected in step 206. Note that this option may be turned on and off through the interface 113, by the driver or owner of the vehicle. Once the data from the vibration sensor is processed, the system 100 also compares, in step 210/304, the processed readings from the vibration sensor with a vibration range stored in the memory 114. The vibration generated by the vibration sensor is associated with an external force exerted on the vehicle, for example, by a person trying to break into the vehicle, or the presence of a heavy piece of equipment that is too close to the vehicle. This data is indicative of a possible danger/threat from outside the vehicle. For this situation, the alert message generated in step 212 may also include an indication that an unexpected force was detected acting on the vehicle. Note that the alert message may include only an indication that a condition inside the cabin is outside a normal range (e.g., temperature, humidity, oxygen level, CO₂ level, etc.), or only an indication that an unexpected force is acting on the cabin, or information about both the condition inside the cabin and the external force. The process discussed above with regard to step 212 of sending a first alert to the driver or owner, and then a second alert to an emergency service or selectively activating a component of the car, equally applies to the external force threat. Informing the owner or driver or any designated person about the external force presence will increase passenger safety within the car during the time the car is parked or stationed.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a method and system that warns a vehicle owner or operator about one or more threatening situations that might happen while a living being is present in the cabin of the stationary vehicle. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
Galatsis, Kosmas, and W Wlodarski. “Car cabin air quality sensors and systems,” in Encycl. Sens 8, 2006.
Al-Kayiem, Hussain H., M. F Bin M. Sidik, Y R Munusamy. “Study on the thermal accumulation and distribution inside a parked car,” in American Journal of Applied Sciences, 2010.
Barradas, Victor, “Air temperature, humidity and human comfort index of some city parks of Mexico City,” Int. J. Biometeorol., 1991 Jun; 35(1): 24-8. doi: 10.1007/BF01040959

1. A vehicle cabin monitoring and warning system comprising:
a sensor array located within a cabin of a vehicle; and
a data server located on the vehicle and in communication with the sensor array,
wherein the data server is configured to determine a presence of a living being inside the cabin based on readings from one or more sensors of the sensor array and
wherein the data server is configured to transmit, in a wireless manner, an alert message to a person associated with the vehicle, the alert message including a location of the vehicle and also an indication about a given parameter that is abnormal with regard to the cabin.

2. The system of claim 1, wherein the given parameter is one of: a temperature inside the cabin, a level of oxygen inside the cabin, a humidity level inside the cabin, a level of CO₂ inside the cabin, and/or an external force exerted on the cabin.

3. The system of claim 1, wherein the given parameter includes a temperature, humidity, and an oxygen level inside the cabin.

4. The system of claim 3, wherein the given parameter further includes an external force exerted on the cabin.

5. The system of claim 1, wherein the given parameter includes a temperature and humidity level inside the cabin.

6. The system of claim 1, wherein the data server is configured to activate the sensor array only when the vehicle is stationary.

7. The system of claim 1, wherein the sensor array comprises:
a motion sensor for determining the presence of the living being; and
an occupancy sensor for also determining the presence of the living being,
wherein the motion sensor uses a different technology than the occupancy sensor for determining the presence of the living being.

8. The system of claim 7, wherein the motion sensor is one of a microwave sensor, an ultrasonic sensor, or a motion detection camera, and the occupancy sensor is one of a capacitive sensor, pressure sensor, microphone, or an infrared sensor.

9. The system of claim 7, wherein the sensor array further comprises:
a temperature and humidity sensor for measuring a temperature and humidity inside the cabin; and
an oxygen sensor for measuring an oxygen level inside the cabin.

10. The system of claim 9, wherein the sensor array further comprises:
a vibration sensor, which is different from the motion sensor and the occupancy sensor, the vibration sensor being configured to measure an external force applied to the cabin,
wherein the given parameter is the external force.

11. A method for monitoring a vehicle cabin and generating an alert message when a threatening situation is detected, the method comprising:
activating a monitoring and warning system located on the vehicle, when the vehicle is stationary for a given time period;
measuring a motion and an occupancy inside the cabin with a sensor array located within the cabin;
determining at a data server of the monitoring and warning system, which is in communication with the sensor array, a presence of a living being inside the cabin, based on readings from the sensor array and
generating and transmitting from the data server an alert message, to a person associated with the vehicle, the alert message including a location of the vehicle and also an indication about a given parameter that is abnormal with regard to the cabin.

12. The method of claim 11, wherein the given parameter is one of: a temperature inside the cabin, a level of oxygen inside the cabin, a humidity level inside the cabin, a level of CO₂ inside the cabin, and/or an external force exerted on the cabin.

13. The method of claim 11, wherein the given parameter includes a temperature, humidity, and an oxygen level inside the cabin.

14. The method of claim 13, wherein the given parameter further includes an external force exerted on the cabin.

15. The method of claim 11, wherein the given parameter includes a temperature and humidity level inside the cabin.

16. The method of claim 11, wherein the data server is configured to activate the sensor array only when the vehicle is stationary.

17. The method of claim 11, further comprising:
determining the presence of the living being with a motion sensor of the sensor array; and
determining the presence of the living being with an occupancy sensor of the sensor array,
wherein the motion sensor uses a different technology than the occupancy sensor.

18. The method of claim 17, wherein the motion sensor is one of a microwave sensor, an ultrasonic sensor, or a motion detection camera, and the occupancy sensor is one of a capacitive sensor, a pressure sensor, a microphone, or an infrared sensor.

19. The method of claim 17, further comprising:
measuring a temperature and humidity inside the cabin with a temperature and humidity sensor of the sensor array; and
measuring an oxygen level inside the cabin with an oxygen sensor of the sensor array.

20. The method of claim 19, further comprising:
measuring an external force applied to the cabin, with a vibration sensor, which is different from the motion sensor and the occupancy sensor, the vibration sensor being part of the sensor array,
wherein the given parameter is the external force.
